(19) United States
(12) Patent Application Publication
(10) Pub. No.: US 2016/0186837 A1
(43) Pub. Date: Jun. 30, 2016

(54) Transmission for a Motor Vehicle

(71) Applicant: ZF FRIEDRICHSHAFEN AG, Friedrichshafen (DE)

(72) Inventors: Stefan Beck, Eriskirch (DE); Christian Sibla, Friedrichshafen (DE)

(21) Appl. No.: 14/907,692

(22) PCT Filed: Jun. 23, 2014
(86) PCT No.: PCT/EP2014/063090

§ 371 Date: Jan. 26, 2016

(30) Foreign Application Priority Data
Jul. 26, 2013 (DE) 10 2013 214 618.3

(51) Int. Cl. F16H 3/66

(52) U.S. Cl. CPC F16H 3/66; F16H 2200/0069; F16H 2200/2012; F16H 2200/2046

(57) ABSTRACT

The invention relates to a transmission, in particular a multi-speed transmission for a motor vehicle, comprising one housing, one drive shaft, one output shaft, at least four planetary gear sets, whereas each of the planetary gear sets has one sun gear, at least one planet, one planetary gear carrier and one ring gear along with several shifting elements in the form of at least four clutches and at least two brakes, whereas the sun gears of at least two planetary gear sets, in particular the sun gears of the first and the second planetary gear sets, are connectable through the first brake to the housing.

The invention relates to a transmission, in particular a multi-speed transmission for a motor vehicle, whereas the transmission comprises one housing, one drive shaft, one [output] shaft and at least four planetary gear sets, whereas each of the planetary gear sets has one sun gear, one planet, one planetary carrier and one ring gear, along with several shifting elements in the form of at least four clutches and at least two brakes.

Such transmissions are known, for example, from WO 2012/052284 A1. WO 2012/0522841 shows a multi-speed transmission with six forward gears and one reverse gear, which comprises four planetary gear sets, seven rotatable shafts and five shifting elements, whereas the sun gear of the first planetary gear set is connected to the sixth shaft, which is attachable to the housing of the transmission through a first brake, whereas the bar of the first planetary gear set is connected to the fifth shaft, which is connected to the sun gear of the second planetary gear set and is attachable to the housing through a second brake, whereas the drive shaft is connected to the ring gear of the first planetary gear set and the sun gear of the third planetary gear set and is detachably connectable through a clutch to the seventh shaft connected to the bar of the third planetary gear set and the ring gear of the fourth planetary gear set, whereas the fourth shaft is connected to the ring gear of the third planetary gear set and to the bar of the second planetary gear set and is attachable to the housing through a third brake, whereas the drive shaft is connected to the ring gear of the second planetary gear set and to the bar of the fourth planetary gear set and whereas the sun gear of the fourth planetary gear set is connected to the third shaft, which is attachable to the housing through a fourth brake.

The disadvantage here is that, with transmissions with a high number of gears, construction costs increase considerably. A higher number of shifting elements, bearings, etc. reduces the advantage of a high number of gears. If there is a large number of open, dragging clutches in the presentation of gears, this leads to high internal efficiency losses.

One task of this invention is to provide an alternative transmission for a motor vehicle. An additional possible task of this invention is to make available a transmission for a motor vehicle, which has a high number of gears and low construction costs, and thus lower costs and lower weight. In addition, a possible task is to make available a good transmission ratio sequence through the transmission, low absolute and relative rotational speeds along with low planetary gear set torques and shifting element torques for the transmission. An additional possible task of this invention is to make available good gearing efficiency and low drag torques.

At least one of the tasks is achieved through a transmission in accordance with claim 1, a method in accordance with claim 8 and a use in accordance with claim 10.

Advantageous embodiments are found in the sub-claims.

In particular, at least one of the above tasks is solved at least partially by a transmission, in particular a multi-speed transmission, for a motor vehicle, whereas the transmission has one housing, one drive shaft, one output shaft and at least four planetary gear sets, and the planetary gear sets have at least one sun gear, at least one planet, at least one planetary gear carrier and at least one ring gear. Moreover, the transmission has several shifting elements in the form of at least four clutches and at least two brakes, whereas
the drive shaft is connected to the planetary gear carrier of the second planetary gear set,
the drive shaft is connectable through the first clutch to the sun gear of the fourth planetary gear set and through the first and the third clutches to the ring gear of the third planetary gear set and through the first, the third and the second clutches to the sun gear of the third planetary gear set and to the ring gear of the second planetary gear set,
the sun gear of the first planetary gear set is connected to the sun gear of the second planetary gear set and to the first brake,
the planetary gear carrier of the first planetary gear set is connected to the ring gear of the fourth planetary gear set and is connectable through the fourth clutch to the planetary gear carrier of the third planetary gear set,
the ring gear of the first planetary gear set is connected to a second brake,
the planetary gear carrier of the fourth planetary gear set is connected to the output shaft.

In particular, the transmission may have more than four planetary sets or, in addition to the planetary gear sets, additional gear sets such as spur gear sets or chains, etc. However, the transmission preferably has only planetary gear sets as gear sets. It is further preferable that the transmission has exactly four planetary gear sets.

At least one of the tasks can be solved by a method for operating a transmission, as has been described above. In particular, at least one of the tasks can be solved at least partially by a method of operating a transmission according to one of the claims 1-7. Moreover, at least one of the tasks is solved, at least partially, by a method for operating a transmission with at least two brakes and at least four clutches, whereas
a first gear is formed by means of a locked first brake, a locked second brake, a locked first clutch, a locked third clutch, and/or is formed by means of a locked first brake, a locked second brake, a locked first clutch and a locked fourth clutch, and/or is formed by means of a locked first brake, a locked second brake, a locked first clutch and a locked second clutch,
a second gear is formed by means of a locked first brake, a locked second brake, a locked second clutch and a locked third clutch,
a third gear is formed by means of a locked second brake, a locked first clutch, a locked second clutch and a locked third clutch,
a fourth gear is formed by means of a locked second brake, a locked second clutch, a locked third clutch and a locked fourth clutch,
a fifth gear is formed by means of a locked second brake, a locked first clutch, a locked second clutch and a locked fourth clutch,
a sixth gear is formed by means of a locked second brake, a locked first clutch, a locked third clutch and a locked fourth clutch,
a seventh gear is formed by means of a locked first clutch, a locked second clutch, a locked third clutch and a locked fourth clutch,
an eighth gear is formed by means of a locked first brake, a locked first clutch, a locked third clutch and a locked fourth clutch,
a ninth gear is formed by means of a locked first brake, a locked first clutch, a locked second clutch and a locked fourth clutch,
a tenth gear is formed by means of a locked first brake, a locked second clutch, a locked third clutch, a locked fourth clutch,
a reverse gear is formed by means of a locked first brake, a locked second brake, a locked third clutch and a locked fourth clutch.

Through the method and/or the transmission, a large number of gears, low construction costs, a good transmission ratio at low absolute and relative rotational speeds can be provided. Additional advantages are the enabling of low planetary gear set torques and shifting element torques, good gearing efficiency and low drag torques.

Through the drive shaft of a drive unit, such as a vehicle drive, it is particularly preferable that a torque or a rotational motion, for example of an internal combustion engine, is introduced into the transmission. In a preferred manner, a starting element is located between the output shaft and the drive shaft of the transmission; this is, for example, a hydrodynamic torque converter or a fluid coupling.

In the following, a “shaft” is not solely understood as an exemplary cylindrical, rotatably mounted machine element for the transfer of torques, but is also understood as a general connection element, which connects individual components or elements to each other, in particular connection elements that connect several elements to each other in a torque-proof manner.

In particular, two elements are described as connected to each other if there is a fixed (in particular, a torque-proof) connection between the elements. In particular, such connected elements rotate with the same rotational speed.

The various components and elements of the specified invention may be connected to each other through a shaft or a connection element, or also directly, for example by means of a welded connection, crimping connection or another connection.

Two elements are described as connectable if there is a detachable connection between such elements. In particular, such elements rotate with the same rotational speed if the connection exists.

Preferably in the description, in particular in the claims, a “clutch” is understood as a shifting element that, depending on the operating state, allows for a relative movement between two components or represents a connection for the transfer of a torque. A “relative movement” is understood as, for example, a rotation of two components, whereas the rotational speed of the first component differs from the rotational speed of the second component. In addition, the rotation of only one of the two components is conceivable, while the other component is at a standstill or rotates in the opposite direction.

A “non-actuated clutch” is understood as an open clutch. This means that a relative movement between the two components is possible. With an actuated or locked clutch, the two components rotate accordingly with the same rotational speed and in the same direction.

In the description, in particular in the claims, a “brake” is understood as a shifting element that is connected on one side to a fixed component, such as a housing, and on another side to a rotatable component.

A “non-actuated brake” is understood as an open brake. This means that the rotatable component is rotatable; that is, the brake preferably does not affect the rotational speed of the rotating component. With an actuated or locked brake, a reduction of the rotational speed of the rotating component up to a stop takes place; that is, a connection between the rotating component and the fixed component can be established.

As a general rule, the use of shifting elements that are locked in a non-actuated state and open in an actuated state is also possible. Accordingly, the allocations between function and shifting state of the shifting states described above are understood in reverse order. With the following embodiments with reference to the figures, an arrangement in which an actuated shifting element is locked and a non-actuated shifting element is open is initially used as the basis.

A “planetary gear set” is understood as a device that has at least one sun gear and at least one ring gear and exactly one planetary gear carrier, whereas at least one, preferably several, planets are rotatably mounted on the planetary gear carrier, which planets mesh in the toothing of the ring gear and/or of the sun gear.

In the following, a negative planetary gear set describes a planetary gear set with a planetary gear carrier on which the planetary gears are rotatably mounted, whereas the toothing of at least one of the planetary gears, preferably all planetary gears, meshes with both the toothing of the sun gear and with the toothing of the ring gear, by which the ring gear and the sun gear rotate in opposite directions, if the sun gear rotates with a fixed planetary carrier.

A positive planetary gear set differs from the negative planetary gear set just described in that the positive planetary gear set has inner and outer planetary gears, which are rotatably mounted on the planetary carrier. Thereby, the toothing of the inner planetary gears meshes, on the one hand, with the toothing of the sun gear and, on the other hand, with the toothing of the outer planetary gears. The toothing of the outer planetary gears meshes with the toothing of the inner planetary gears and with the toothing of the ring gear. This has the consequence that, with a fixed planetary carrier, the ring gear and the sun gear rotate with the same direction of rotation.

A particularly compact transmission can be realized through the use of planetary gear sets, by which a high degree of freedom in the arrangement of the transmission in the vehicle is achieved.

In particular, the sun gear, the ring gear, the planetary gear carrier or the bar and the planetary gears or the planets of the planetary gear set are understood as elements of a planetary gear set.

It is particularly preferable that the shifting elements are able to be actuated selectively, thus individually and in line with demand, by which different gears can be realized through different transmission ratio relationships between the drive shaft and the drive shaft of the transmission. The higher the number of gears, the finer a gear shifting with a large gear spread can be realized, and thus, for example, an internal combustion engine of a motor vehicle can be operated in an optimum rotational speed range and therefore as economically as possible. At the same time, this contributes to increased efficiency, since the internal combustion engine preferably can be operated at a low rotational speed level. Thus, for example, noise emissions that arise through the operation of the internal combustion engine are reduced.

The presented transmission is suitable for both a longitudinal arrangement as well as a transverse arrangement.

The term “transverse arrangement” is understood as an arrangement with which the output shaft of the drive unit, for example of the internal combustion engine, is transverse to a direction of travel and/or the main vehicle axle or parallel to this in a motor vehicle. The transmission presented here is more suitable for a “front-transverse arrangement,” which is characterized in that the output shaft of the drive unit is arranged transverse to the direction of travel and the wheels on one front axle can be driven by the drive unit. Since, with the front-transverse arrangement, the transmission is usually located in or right next to the engine compartment, it is necessary that the transmission is formed in a particularly compact manner.

Moreover, the transmission is suitable for a longitudinal arrangement. A longitudinal arrangement is characterized by the fact that the output shaft of the drive unit extends along the direction of travel and/or the main vehicle axis or parallel thereto. In particular, the transmission is suitable for a rear longitudinal arrangement, with which the output shaft of the drive unit extends along the main vehicle axis or parallel thereto, and the rear wheels are connected to the drive unit by means of the transmission.

Furthermore, the shifting elements may be formed in such a manner that energy is required for a change of the shifting state of the shifting elements, but not for maintaining the shifting state itself.

For this purpose, actuated shifting elements in line with demand, such as electromechanical shifting elements or electromagnetic shifting elements, are suitable in a particular way. Particularly when compared to conventional hydraulically actuated shifting elements, they are characterized by a particularly low and efficient energy demand, since they can be operated almost loss-free. In addition, in an advantageous manner, permanently holding a pressure for the actuation of the (for example) conventional hydraulic shifting elements, and/or permanently subjecting the shifting element in the locked state to the required hydraulic pressure, can be avoided. Thereby, additional components such as a hydraulic pump (for example) may be omitted, to the extent that they are solely used for the control and supply of conventional hydraulically actuated shifting elements. If the additional components are supplied with lubricants by the same hydraulic pump, and not by a separate lubrication pump, at least this can be dimensioned smaller. Moreover, any leaks at the transfer points of the oil circuit that may arise, particularly with rotating components, are eliminated. It is particularly preferable that this also contributes to increased efficiency of the transmission in the form of a higher degree of efficiency. Upon the use of actuated shifting elements in line with demand of the type specified above, it is particularly sensible if they are easily accessible from the outside. Among other things, that has the advantage that the required shifting energy can be easily fed to the shifting elements. As such, shifting elements are preferably arranged such that they are easily accessible from the outside. In the context of the shifting elements, “easily accessible from the outside” means that no additional components are arranged between the housing of the transmission and the shifting element, or that the shifting elements are arranged on the output shaft or on the drive shaft.

In the description, in particular in the claims, the term “binding ability” is preferably understood such that, with a different geometrical positioning, the same connection of the interfaces is ensured, without the individual connection elements or shafts crossing each other.

The term “stationary transmission ratio” is understood as that transmission ratio that is realized by the transmission ratio relationship between the sun gear and the ring gear of the respective planetary gear set if the planetary carrier or bar, as the case may be, is fixed.

Advantageously, the planetary gear sets in the transmission are arranged in succession. This enables simple manufacturing and easy accessibility of the planetary gear sets in the event of maintenance. Preferably, the planetary gear sets are arranged geometrically in the order of first planetary gear set, second planetary gear set, third planetary gear set, fourth planetary gear set.

Preferably, the axes of rotation of the sun gears, ring gears and planetary gear carriers of the planetary gear sets are parallel to each other.

Beneficially, all planetary gear sets are negative planetary gear sets. In this manner, the ring gear and the sun gear can rotate in opposite directions of rotation of the respective planetary gear set, if the sun gear rotates with a fixed planetary carrier. In addition, compared to positive planetary gear sets, negative planetary gear sets have fewer components, which can lead to a weight advantage, efficiency advantage and maintenance advantage.

Advantageously, the amount of the stationary transmission ratio of the first, the second and the third planetary gear sets≦2. In particular, the amount of the stationary transmission ratio of the first planetary gear set is 2, of the second planetary gear set is 1.8, of the third planetary gear set is 1.8, and of the fourth planetary gear set is 3.6. Moreover, one or more of the planetary gear sets is formed as a positive planetary gear set; this particularly applies if the bar connection and the ring gear connection are exchanged and the amount of the stationary transmission ratio is increased by 1.

Additional important characteristics and advantages of the invention arise from the subclaims, from the drawings, and from the associated description of the figures on the basis of the drawings.

It is understood that the characteristics specified above and the characteristics that are still to be described below are usable not only in the indicated combination, but also in other combinations or alone, without leaving the framework of the present invention.

Preferred designs and embodiments of the invention are presented in the drawings and are described more specifically in the following description, whereas the same reference signs refer to identical or similar functional components or elements. The following are shown, each in schematic form:

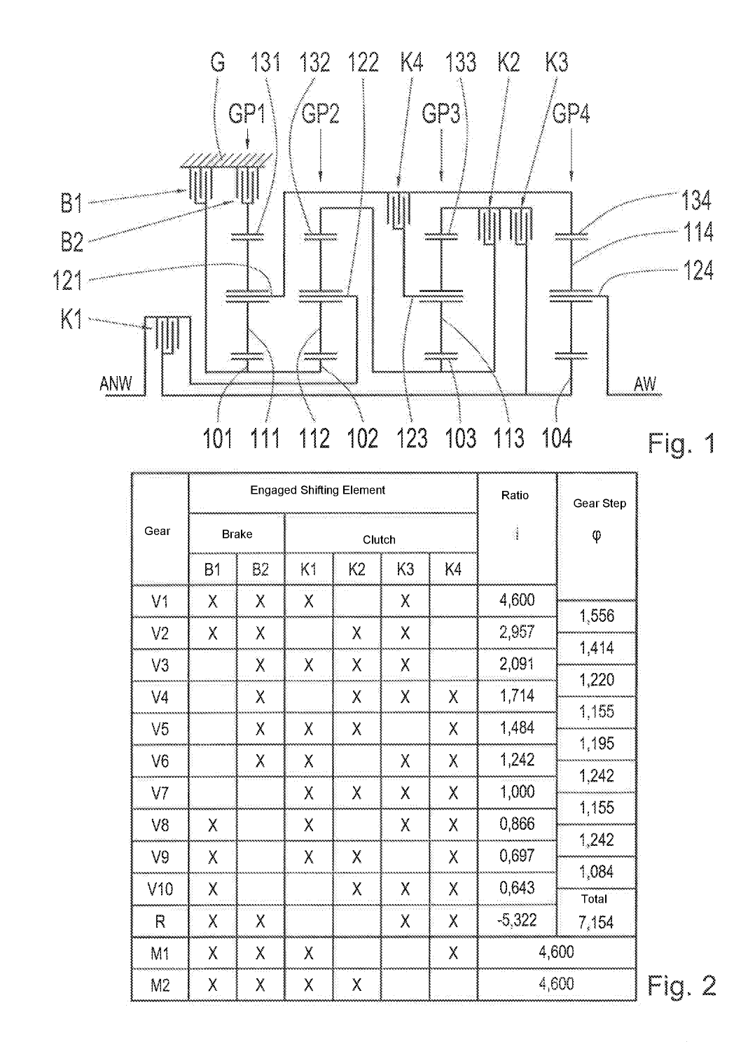

FIG. 1 a transmission in accordance with an embodiment of the present invention;

FIG. 2 a shifting matrix for a transmission in accordance with FIG. 1.

FIG. 1 shows a transmission in accordance with an embodiment of the present invention.

In FIG. 1 shows a multi-speed transmission 1. The multi-speed transmission 1 has six shifting elements in the form of four clutches K1, K2, K3, K4 and two brakes B1, B2. By means of the four clutches K1, K2, K3, K4, the drive side can be coupled or connected to the output side of the transmission 1 for transferring power and torques through shafts, shifting elements and/or the planetary gear sets.

Below, the general structure of the first planetary gear set GP1, the second planetary gear set GP2, the third planetary gear set GP3 and the fourth planetary gear set GP4 will be initially described. The planetary gear sets GP1, GP2, GP3 and GP4 specified above are constructed in the usual manner, and each has a central sun gear 101, 102, 103, 104, which works together with at least one planet 111, 112, 113, 114 for transferring force and torque. The planets 111, 112, 113, 114 are rotatably mounted on a bar/planetary gear carrier 121, 122, 123, 124. On the radially outer side of the planet 111, 112, 113, 114, a ring gear 131, 132, 133, 134 is arranged, in which the respective planet 111, 112, 113, 114 is engaged for transferring force and torque. Each of the bars/planetary carriers 121, 122, 123, 124 is further connected to a shaft.

In FIG. 1, the drive shaft ANW is connected to the bar 122 of the second planetary gear set GP2 and is connectable through the first clutch K1 to the sun gear 104 of the fourth planetary gear set GP4. Moreover, the drive shaft ANW is connectable, through the first clutch K1 and the third clutch K3, to the ring gear 133 of the third planetary gear set GP3 and, through the first clutch K1, the third clutch K3 and the second clutch K2, to the sun gear 103 of the third planetary gear set GP3 and to the ring gear 132 of the second planetary gear set GP2. The output shaft AW is connected to the bar 124 of the fourth planetary gear set GP4. The ring gear 131 of the first planetary gear set GP1 is connected through the second brake B2 to the housing G. The sun gear 101 of the first planetary gear set GP1 is connected to the sun gear 102 of the second planetary gear set GP2 and is connectable through the first brake B1 to the housing G. The bar 121 of the first planetary gear set GP1 is connected to the ring gear 134 of the fourth planetary set GP4 and is connectable through the fourth clutch K4 to the bar 123 of the third planetary gear set GP3. The ring gear of the second planetary gear 132 is connected to the sun gear 103 of the third planetary gear set GP3.

FIG. 2 shows a shifting matrix for a transmission in accordance with FIG. 1.

Downwards in a vertical direction, ten forward gears V1-V10 along with one reverse gear, designated with R, are initially shown. In addition, two additional gears M1 and M2, which correspond to the first gear V1 in the transmission ratio, are presented. Each of the shifting elements is shown horizontally, whereas the two brakes B1, B2 are initially shown, and the four clutches K1, K2, K3 and K4 are then shown. Furthermore, the respective transmission ratio relationship i and the corresponding gear jump φ is shown between two consecutive gears. The entries left empty in the shifting matrix, thus, for example, with the forward gear V1, the second clutch K2 and the fourth clutch K4 indicate that the corresponding shifting element or brake or clutch, as the case may be, is open; i.e., that the shifting element thereby does not transfer any power or torque from the respective shafts or elements of the transmission attached to the shifting element or connected to it. An entry in the shifting matrix provided with a cross designates a correspondingly actuated or locked shifting element, thus in the shifting matrix, for example, with the forward gear V2, with the first brake B1, the second brake B2, along with the second clutch K2 and the third clutch K3.

In order to present the first forward gear by means of the transmission 1 in accordance with FIG. 1, the first brake B1 and the second brake B2 along with the first clutch K1 and the third clutch K3 are locked. The second clutch K2 and the fourth clutch K4 are open. The transmission ratio relationship i amounts to 4.600.

In order to present the second forward gear V2, the first brake B1, the second brake B2, along with the second clutch K2 and the third clutch K3 are locked. The first clutch K1 and the fourth clutch K4 are open. The transmission ratio relationship i amounts to 2.957. The gear jump between the first gear V1 and the second gear V2 amounts to 1.556.

In order to present the third reverse gear V3, the second brake B2, the first clutch K1, the second clutch K2 and the third clutch K3 are locked. The first brake B1 and the fourth clutch K4 are open. The transmission ratio relationship i amounts to 2.091. The gear jump φ between the second gear V2 and the third gear V3 amounts to 1.414.

In order to present the fourth gear V4, the second brake B2, the second clutch K2, the third clutch K3 and the fourth clutch K4 are locked. The first brake B1 and the first clutch K1 are open. The transmission ratio relationship amounts to 1.714. The gear jump between the third gear V3 and the fourth gear V4 amounts to 1.220.

In order to present the fifth gear V5, the second brake B2, the first clutch K1, the second clutch K2 and the fourth clutch K4 are locked. The first brake B1 and the third clutch K3 are open. The transmission ratio relationship amounts to 1.484. The gear jump between the fourth gear V4 and the fifth gear V5 amounts to 1.155.

In order to present the sixth gear V6, the second brake B2, the first clutch K1, the third clutch K3 and the fourth clutch K4 are locked. The first brake B1 and the second clutch K2 are open. The transmission ratio relationship amounts to 1.242. The gear jump between the fifth gear V5 and sixth gear V6 amounts to 1.195.

In order to present the seventh gear V7, the first clutch K1, the second clutch K2, the third clutch K3 and the fourth clutch K4 are locked. The first brake B1 and the second brake B2 are open. The transmission ratio relationship amounts to 1.000. The gear jump between the sixth gear V6 and the seventh gear V7 amounts to 1.242.

In order to present the eighth gear V8, the first brake B1, the first clutch K1, the third clutch K3 and the fourth clutch K4 are locked. The second brake B2 and the second clutch K2 are open. The transmission ratio relationship amounts to 0.866. The gear jump between the seventh gear V7 and the eighth gear V8 amounts to 1.155.

In order to present the ninth gear V9, the first brake B1, the first clutch K1, the second clutch K2 and the fourth clutch K4 are locked. The second brake B2 and the third clutch K3 are open. The transmission ratio relationship amounts to 0.697. The gear jump φ between the eighth gear V8 and the ninth gear V9 amounts to 1.242.

In order to present the tenth gear V10, the first brake B1, second clutch K2, the third clutch K3 and the fourth clutch K4 are locked. The second brake B2 and the first clutch K1 are open. The transmission ratio relationship i amounts to 0.643. The gear jump between the ninth gear V9 and the tenth gear V10 amounts to 1.084.

In order to present the reverse gear, the first brake B1 is locked, the second brake B2 is locked, and the third clutch K3 and the fourth clutch K4 are locked. The first clutch K1 and the second clutch K2 are open. The transmission ratio relationship amounts to −5.322.

As an alternative to the first gear V1, the gears M1 or M2 can be used. In order to present the first alternative gear M1, the first brake B1, the second brake B2, the first clutch K1 and the fourth clutch K4 are locked. The second clutch K2 and the third clutch K3 are open. The transmission ratio relationship amounts to 4.600.

In order to present the second alternative gear M2, the first brake B1, the second brake B2, the first clutch K1 and the second clutch K2 are locked. The third clutch K3 and the fourth clutch K4 are open. The transmission ratio relationship amounts to 4.600.

In order to go from one gear to the adjacent gear, in each case, one shifting element must be open and one shifting element must be locked.

Overall, the transmission in accordance with FIGS. 1 and 2 comprises four planetary gear sets GP1, GP2, GP3, GP4 and six shifting elements K1, K2, K3, K4, B1, B2, whereas the shifting elements are formed in the form of at least four clutches K1, K2, K3, K4 and at least two brakes B1, B2. For each gear, two shifting elements are open and four shifting elements are locked. A fixed housing coupling is not present. By means of the transmission 1 in accordance with FIGS. 1 and 2, at least ten forward gears and at least one reverse gear can be presented. A hydrodynamic torque converter, a hydrodynamic coupling, an additional starting clutch, an integrated starting clutch or brake and/or an additional electric motor can be arranged as a start-up element for the transmission 1. On each of the shafts of the transmission 1, it is possible to arrange an electric motor or another source of force/power. Moreover, at each shaft, a freewheel is arranged for the housing G or for another shaft. Preferably, the transmission 1 can be installed in a vehicle in standard drive design or in front/transverse design. Frictional-locking shifting elements and/or positive-locking shifting elements are possible as shifting elements. In particular, the second brake B2 may be designed as a positive-locking shifting element, in particular as a claw shifting element, which leads to significant consumption advantages of a vehicle with an internal combustion engine that is provided with the transmission.

In summary, this invention offers the advantage that low construction costs are required for the transmission, which results in lower manufacturing costs and lower weight of the transmission. In addition, the transmission offers a good transmission ratio sequence, low absolute and relative rotational speeds and low planetary gear set torques and shifting element torques. Moreover, this invention offers good gearing efficiency, a high number of gears and low drag torques. Although this invention has been described with reference to preferred embodiments, it is not limited to them, but can be modified in many ways.

Thus, for example, the geometric position/sequence of the individual planetary gear sets and the individual shifting elements can be freely selected among each other under consideration of the binding ability of the respective transmission elements. Individual transmission elements can be moved arbitrarily into their positions within the transmission. It is also possible to, under consideration of binding ability, convert one or more planetary gear sets formed as negative planetary gear sets into positive/negative planetary gear sets, with a simultaneous exchange of the bar connections and the ring gear connections and an increase in the stationary transmission ratio by 1.

### REFERENCE SIGNS

1 Transmission
GP1, GP2, GP3, GP4 Planetary gear set
101, 102, 103, 104 Sun gear
111, 112, 113, 114 Planetary gear
121, 122, 123, 124 Bar
131, 132, 133, 134 Ring gear
ANW Drive shaft
AW Output shaft
B1, B2, Brake
K1, K2, K3, K4 Clutch
G Housing
V1, V2, V3, V4, V5, V6, V7, V8, V9, V10 Forward gear
M1, M2 Alternative forward gear
R Reverse gear
i Transmission ratio
φ Gear jump

1. Transmission (1), in particular a multi-speed transmission for a motor vehicle, comprising a housing (G), a drive shaft (ANW), an output shaft (AW), at least four planetary gear sets (GP1, GP2, GP3, GP4), whereas each of the planetary gear sets (GP1, GP2, GP3, GP4) has one sun gear (101, 102, 103, 104), one planet (111, 112, 113, 114), one planetary carrier (121, 122, 123, 124) and one ring gear (131, 132, 133, 134), along with several shifting elements (K1, K2, K3, K4, B1, B2) in the form of at least four clutches (K1, K2, K3, K4) and at least two brakes (B1, B2), characterized in that
the drive shaft (ANW) is connected to the planetary carrier (122) of the second planetary gear set,
the drive shaft (ANW) is connectable through the first clutch (K1) to the sun gear (104) of the fourth planetary gear set (GP4) and through the first (K1) and the third clutches (K3) to the ring gear (133) of the third planetary gear set (GP3) and through the first clutch (K1), the third clutch (K3) and the second clutch (K2) to the sun gear (123) of the third planetary gear set (GP3) and to the ring gear (132) of the second planetary gear set (GP2),
the sun gear (101) of the first planetary gear set (GP1) is connected to the sun gear (102) of the second planetary gear set (GP2) and to the first brake (B1),
the planetary gear carrier (121) of the first planetary gear set (GP1) is connected to the ring gear (134) of the fourth planetary gear set (GP4) and is connected through the fourth clutch (K4) to the planetary gear carrier (123) of the third planetary gear set (GP3),
the ring gear (131) of the first planetary gear set (GP1) is connected to a second brake (B2),
the planetary gear carrier (124) of the fourth planetary gear set (GP4) is connected to the output shaft (AW).

2-10. (canceled)
